(19) United States
(12) Patent Application Publication
(10) Pub. No.: US 2009/0120050 A1
(43) Pub. Date: May 14, 2009

(54) Fruit Harvesting Machine for Trees, Shrubs and the Like

(76) Inventor: Carlos Enrique Constans, Buenos Aires (AR)

Correspondence Address: HOWREY LLP-HN, C/O IP DOCKETING DEPARTMENT, 2941 FAIRVIEW PARK DRIVE, SUITE 200, FALLS CHURCH, VA, 22042-7195, US

(21) Appl. No.: 11/990,370

(22) PCT Filed: Aug. 12, 2005
(86) PCT No.: PCT/US2005/028879

§ 371 Date: Feb. 12, 2008

(51) Int. Cl. A01D 46/00

(52) U.S. Cl. 56/328.1

(57) ABSTRACT

A fruit harvesting machine for trees, shrubs and the like planted in rows, which applies a controlled intensity and direction blast wave to dislodge the fruit from the tree. The fruit-harvesting machine makes use of the advantages of using blast wave generating devices which have a combustion chamber and the combined effect of blast waves with the every released by gases during an explosion to dislodge the fruit from the tree. Additionally, the harvesting machine uses the emission of short, high intensity light pulses directed towards the fruit to be harvested, these pulses act spatially and deactivate microorganisms which are pathogenic for humans and plants.

### BACKGROUND OF THE INVENTION

1. Field of the Invention

This invention concerns a fruit harvesting machine for trees, shrubs and the like, planted in rows, which applies a controlled intensity and direction blast wave to dislodge the fruit from the tree. In particular, the invention concerns a fruit-harvesting machine that makes use of the advantages of using blast wave generating devices which have a combustion chamber and the combined effect of blast waves with the energy released by gases during an explosion to dislodge the fruit from the tree. Additionally, the harvesting machine of the present invention uses the emission of short, high intensity light purses directed towards the fruit which is to be harvested, these pulses act spatially and deactivate microorganisms which are pathogenic for humans and plants.

2. Description of the Prior Art

At present, the mechanical harvesting of fruit, in particular of olives, makes use of various types of agricultural machine. One which is known as a “vibrator” type holds the olive tree at the trunk and causes its fruit—the olives—to become detached by means of vibration, and to fall onto the ground, or more precisely, onto pieces of cloth placed around the olive tree. Another type of machine uses vertical poles that knock the olive tree horizontally. Such poles are seated vertically on a mechanical vibrating platform. The lateral knocking of the pole causes the fruits of the olive tree to fall vertically onto the pieces of cloth placed on the ground around the tree ready to be gathered afterwards. A further type of machine makes use of vacuum to pick the fruit and convey it to a bin. This is not only costly but the vacuum needs to be directed to each fruit to be harvested. Yet another type of machine employs a twisting mechanism to twist the fruit. This type of twisting mechanism is usually complex and costly. Finally, another type of machine uses compressed air blasts directed in various directions to produce the abscission of the fruit. These blasts, because of their duration, apply a progressive force to the fruit, which reduces the possibility of producing an effective abscission.

The limitations of these conventional systems have led to a demand for new, improved harvesting machines which incorporate new technologies to overcome the many problems of the prior art. Consequently the harvesting machine of the present invention which has been developed using blast waves from an explosion in a combustion chamber together with the emission of short high intensity light pulses has many diverse advantages to consider.

A search of the state of the art has revealed the existence of U.S. Pat. No. 3,871,040 Carmelo Marasco, U.S. Pat. No. 4,134,250 and U.S. Pat. No. 4,175,368 to Edward D. Scheffler, U.S. Pat. No. 4,212,148 to J. O. Brownlee and U.S. Pat. No. 6,609,359 to Miguel Pelagio Teixeira da Costa.

### SUMMARY OF THE INVENTION

According to the advantageous characteristics of the harvesting machine of this invention, no specific type of plantation, plant, or tree distribution is necessary nor is the density a limitation, even if a tree has more than one trunk, the trunk is deformed or the trunk diameter is large.

Among the advantages of using the harvesting machine of the present invention the following are to be noted:
The maximum yield allowed by soil, area and sunlight;
Cost reduction with regards to cultivation, pruning and harvesting;
Absolute minimum damage to plants and trees especially bark, and small branches;
Minimization of fruit damage;
Harvesting machine can be used on all kinds of terrains

It is therefore an object of this invention to provide a machine for harvesting fruit from trees, shrubs and the like, using controlled intensity and direction blast waves, wherein said machine is defined by a structure mounted on wheels having a first and a second side enclosing a space for surrounding the tree whose fruits are to be harvested, including on each side a plurality of blast generator devices attached to the first and second sides and adjustably aimed to the tree, said devices capable of producing a blast wave to dislodge the fruit from the tree.

Another object of the present invention is to provide a machine for harvesting fruit from trees, shrubs and the like wherein the blast generator devices also generate short, high intensity light flashes capable of attacking and deactivating pathogenic microorganisms and the microbial population generally present on the skin of fruit to be harvested.

The technology used in the present invention is based on the use of blast waves. The [symbol] its efficiency. The operative conditions may be adjusted based on the resistance of fruits to abscission, size and shape and can easily be regulated in a simple way without any need to change or modify harvesting tools. The use of blast waves is in fact very similar to manual harvesting where the pressure of the fingers is evenly distributed on the fruit for picking. The blast waves that are achieved with different types of combustion elements act applying an even pressure onto the fruit surface.

A blast wave is a sharply defined wave of increased pressure rapidly propagated through a surrounding medium from a center of detonation or similar disturbance.

A blast wave produces:
A sudden compression (static pressure) followed by
A strong outward wind (dynamic Pressure)

A near-ideal explosion that is generated by a spherically symmetric source, and that occurs in a still, homogeneous atmosphere, would result in a pressure-time history. The pressure is at ambient value until the air-blast arrives. At this time it instantaneously rises to its peak side-on overpressure, decays back to ambient, drops to a partial vacuum, and eventually returns to ambient. It is this transient phenomenon that is exploited in the present invention to achieve the abscission of fruit from the tree. After the explosion the resulting expanding gases hit anything in their path. This action is very short lived and will decrease rapidly with distance. The specific impulse of the explosion of the gases will be greater when the load and diffusion velocity increase and as the distance (R) between the source of the explosion and the object hit decreases. As distance increases the area on which the force of the blast wave acts increases with the square of the distance (R). The specific impulse can be expressed as:

$$I = A \frac{Q}{{R}^{2}} cos α$$

Where A is a constant depending on the explosive substance, Q is the amount of explosive charge and R in the distance between the explosive charge and the object to be harvested, and □ is the angle of incidence of the impulse.

The use of high intensity light is well known to kill or deactivate bacteria. Using light pulses to reduce bacterial contamination has been used in many industrial processes but is not used specifically in the field at the time of harvest to reduce contamination in trees and shrubs surface. These light pulses can be used to eliminate or reduce the use of chemical products in agriculture.

The light spectra used for this purpose includes light within the range of ultraviolet and near infrared. The trees, shrubs and fruit are exposed to a light pulse having an energy density in the interval of at least between 0.01 and 50 J/cm² on the surface. The energy used is light with an intensity 20.000 times that of the sun on the earth and includes electromagnetic waves with wavelengths that are not present in solar light being filtered by the atmosphere surrounding the earth.

The deactivation of certain resistant microorganisms requires treatment with the complete spectrum; others are deactivated with a filtered spectrum.

The proposed process uses short duration light flashes of broad-spectrum white light to deactivate a wide range of microorganisms including bacterial and fungi spores.

The flashes are applied normally at between 1 and 20 flashes per second. In most applications, a few flashes applied in a fraction of a second provide a high level of microbial deactivation.

The PulseBright® system uses a technique known as process with pulsed energy. The process starts storing electricity in a capacitor and releasing short high intensity pulses. The stored energy pulsates an inert gas lamp to produce a high intensity flash lasting only a few microseconds. The gas lamps, when pulsated with an electric current, produce a wide band white light. The electric current ionizes the gas giving out a flash with a bandwidth of between 200 nm and 1 nm. These lamps normally use xenon or krypton due to their high efficiency. The frequency of the flashing is selected in each case according to the type of fruit being harvested. The lamps may be flashing simultaneously or sequentially. The number of lamps, flashing configuration, and pulse velocity will vary with the type fruit and treatment needed.

Other characteristics and advantages will become apparent in the following description and accompanying figures.

### BRIEF DESCRIPTION OF THE DRAWINGS

FIG. 1 is a front view of the harvesting machine of the invention illustrating how it is placed to harvest fruit from a tree enclosed by the machine.

FIG. 2 shows one type of blast wave generator used with the harvesting machine.

FIG. 3 is a side view of the blast wave generator of FIG. 2 showing the combustion chamber and the expansion chamber.

### DETAILED DESCRIPTION OF THE INVENTION

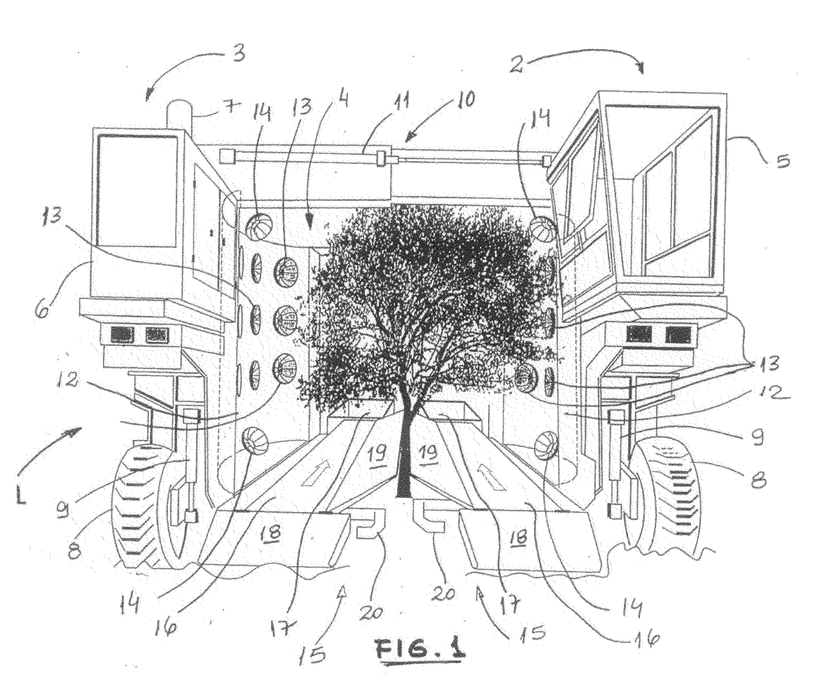

FIG. 1 shows the harvesting machine referred to as 1 for harvesting fruit using controlled intensity and direction blast waves, and which is defined by a structure mounted on wheels having a first side 2 and a second side 3 enclosing a space 4 for surrounding the tree whose fruits are to be harvested. The first side 2 carries an operator's cab for general operation and control of the machine. The second side 3 carries a power and service unit 6 to generate the energy required to move the machine as well as other operational needs. This unit 6 includes a conduit 7 with a silencer for the evacuation of fumes. Sides 2 and 3 are mounted on wheels 8 which are coupled to hydraulic mechanisms for the automatic regulation of the height of the machine as it travels on the terrain and these sides are linked by the overhead machine 1 width regulating devices for adjusting the separation of both sides in accordance to the requirements of the plantation to be harvested. These regulating devices include a telescopic structure 10 associated to a hydraulic cylinder 11.

On the inside of sides 2 and 3 of the machine 1 there are substantially vertical panels 12 having an approximately semi-circular, concave shape defining the corresponding supports for a plurality of blast wave generators 13 where explosions generate the blast waves to produce the abscission of fruits from the tree. The concave shape of the panels 12 allows the placement of the blast wave generators 13 so that when they produce blast waves these are directed so as to cover the branches of the tree through multiple converging blast waves. With medium intensity blast waves the speed is in the order of 60 to 80 meters per second, enough to produce the abscission of fruit from the branches. With less intensity, lower speeds are achieved so that the speed can be adjusted according to the needs of each particular plantation.

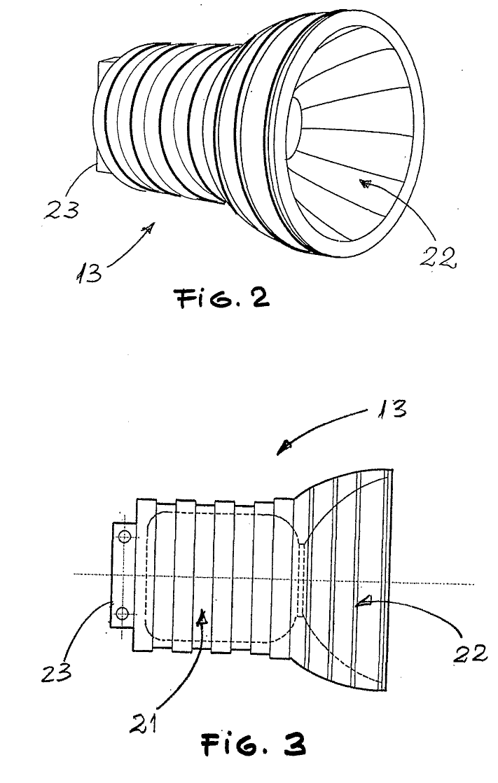

FIGS. 2 and 3 illustrate a type of blast wave generator 13 having a rear combustion [symbol] projects the blast waves. Each generator 13 has a rear jutting-out piece 23 for attaching to panel 12. Hydrogen is used as a combustion fuel to generate the explosions in the combustion chamber. In another embodiment and as described in FIG. 1, the light flashes can also be generated by the combustion chamber 21 of generators 13 by the reacting hydrogen. The use of hydrogen is most convenient as, among other advantages, it is common in nature, it is almost inert at room temperature, is dissipated in ventilated areas, has no known adverse effects on plants or animals and as a final by product. After detonating when combined with the oxygen in the air it produces water which is safe for the environment.

Returning to FIG. 1, the light flashes are generally produced according to the present embodiment, by lamps 14 which emit high intensity short light pulses which, as shown, are preferably placed at the top and at the bottom of the panels 12 and directed towards the trees' branches. Note that with wavelengths of between infrared and ultraviolet, the short light pulses can deactivate a wide range of microorganisms including bacteria and fungi. In most cases, a few flashes applied in a fraction of a second will provide a high level of microbial deactivation. Therefore, the process is very quick and gives the possibility of high production or treatment. In general, the fruit to be sterilized is exposed to light flashes of about 1 microsecond to 0.1 second applied at a rate of 1 to 20 flashes per second with an intensity of about 0.01 to 50 J/cm² on the surface or skin of the fruit. At least 70% of the electromagnetic energy is distributed in the range of 170 nm to 2,600 nm. With these values of time, wavelength and frequency emitted by the lamps 14 acting spatially it is possible to attack and efficiently deactivate the pathogenic microorganisms and the microbial population which are generally found on the skin of fruit.

The number of blast wave generators 13, the operational frequency, and the configuration and velocity of the detonations, all depend on the type of product to be harvested, the tree and the equipment used to transport and support the generators.

Following with the description of the harvester 1 and FIG. 1, it can be observed that in the enclosed space 4 collecting platforms 15 project outwards from the lower part of sides 2 and 3 respectively in order to collect the fruit dropped from the tree. Each platform includes a conveyor belt 16 to convey the fruit towards a bin 17 placed at the back of the machine 1. In addition, at the other end of the platforms 15, at the front end the machine 1, plates 18 are placed facing downwards to protect the lower branches of the tree. From the edge of the platforms 15 facing the center of the space 4 there are plates 19 which project outwards to receive and direct fallen fruit to the conveyor belts 16 on which they are conveyed to the bins 17. The plates 19 are adjustable and can be slanted to accommodate for the normal advance of the machine. Under the platforms 15 at the front the machine 1 there are lateral guides 20 to provide for the alignment of the machine with the row of trees in the plantation.

It is to be understood that the invention is not to be limited to the exact details of operation or structure shown and described, as obvious modifications and equivalents will be apparent to one skilled in the art.

1. A fruit harvesting machine for trees, shrubs and the like comprising:
a structure mounted on wheels having a first and a second side enclosing a space for surrounding the tree whose fruits are to be harvested;
a plurality of blast generator devices attached to panels on the inside of the first and second sides and adjustably aimed towards the tree, said devices being capable of producing a blast wave to dislodge the fruits from the tree.

2. The machine according to claim 1 wherein said blast generator devices comprise a combustion chamber and an expansion chamber, said expansion chamber to project the blast waves from the device towards the tree.

3. The machine according to claim 2 wherein said combustion chamber uses hydrogen as a combustion fuel to generate explosions that produce blast waves.

4. The machine according to claim 2 wherein said blast waves have a maximum velocity of between 60 and 80 meters per second.

5. The machine according to claim 3 wherein said blast generator devices also produce the emission of short high intensity light pulses capable of attacking and deactivating pathogenic microorganisms and microbial populations generally found on the surface of the fruit to be harvested.

6. The machine according to claim 5 wherein said light flashes are generated in the combustion chamber as a reaction to the hydrogen combining with oxygen present in the air.

7. The machine according to claim 3 further comprising a plurality of high intensity short pulsating, light emitting lamps.

8. The machine according to claim 7 wherein said plurality of high intensity short pulsating light emitting lamps placed at least at the top and the bottom of each of said first and second sides are capable of being directed towards the top of the tree.

9. The machine according to claims 4 to 8 wherein said light flashes have a duration of between 1 microsecond and 0.1 seconds and are applied at a frequency of between 1 and 20 flashes per second.

10. The machine according to any of the preceding claims wherein said first side carries an operator's cab for general operation and control of the machine and wherein said second side carries a power and service unit.

11. The machine according to any of the preceding claims wherein said first and second sides are linked by overhead width adjusting devices for adjusting the separation of both sides in accordance to the requirements of the plantation to be harvested.

12. The machine according to claim 11 wherein said adjusting mechanism is defined by a telescoping structure associated to a hydraulic cylinder to be used for operation.

13. The machine according to any of the preceding claims wherein at the bottom of each of said sides respective collecting platforms are placed to collect the harvested fruit.

14. The machine according to claim 13 wherein each of said collecting platforms includes a conveyor belt to convey the collected fruit towards respective bins at the back end of the machine.

15. The machine according to claim 14 wherein in front of each conveyor belt at the front of the machine protector plates are placed for the protection of low lying branches.

16. The machine according to claims 13, 14 or 15 wherein on the inner side of each conveyor belt guide plates are located to receive fruit and guide it towards the conveyor belts, said guide plates being adjustable to accommodate to the space available for the normal advance of the machine within the plantation.

17. The machine according to any of claims 13 through 17 wherein at the front of the machine and under said protector plates lateral guides are provided for the advance of the machine in line with the plantation.

18. The machine according to any of the preceding claims wherein said wheels are coupled to a hydraulic mechanism for adjusting the height of the machine according to the terrain.
